(19) United States
(12) Patent Application Publication
(10) Pub. No.: US 2014/0231239 A1
(43) Pub. Date: Aug. 21, 2014

(54) BIN SYSTEM AND CHAR RECOVERY APPARATUS

(71) Applicant: MITSUBISHI HEAVY INDUSTRIES, LTD., Tokyo (JP)

(72) Inventors: Yoshinori Koyama, Tokyo (JP); Yuichiro Urakata, Tokyo (JP); Osamu Shinada, Tokyo (JP); Yasunari Shibata, Tokyo (JP); Takashi Yamamoto, Tokyo (JP); Koji Nishimura, Tokyo (JP); Hiromi Ishii, Tokyo (JP)

(73) Assignee: MITSUBISHI HEAVY INDUSTRIES, LTD., Tokyo (JP)

(21) Appl. No.: 14/348,177

(22) PCT Filed: Nov. 22, 2012
(86) PCT No.: PCT/JP2012/080393

§ 371 Date: Mar. 28, 2014

(30) Foreign Application Priority Data
Nov. 25, 2011 (JP) 2011-258023

(51) Int. Cl. B65G 65/32; B65G 53/04

(52) U.S. Cl. CPC B65G 65/32; B65G 53/04
USPC 202/261; 414/293

(57) ABSTRACT

In a bin system and a char recovery apparatus, reduction in size of the apparatus can be achieved. Provided are: a bin (44) that can store char; three char discharge lines (47, 49a, 49b) that are arranged at a predetermined inclination angle at which the char can be discharged in the bin (44) by means of gravitational fall; four switching lines (51a, 51b, 51c, 51d) that are arranged at the predetermined inclination angle theta at which the char stored in the bin (44) can be fed by means of the gravitational fall; and assist gas feed parts (54, 55a, 55b) as an assist device that assist flow of the char gravitationally falling down the char discharge lines (47, 49a, 49b).

### TECHNICAL FIELD

The present invention relates to a bin system used for a char recovery apparatus of an integrated coal gasification combined cycle, and the char recovery apparatus.

### BACKGROUND ART

An integrated coal gasification combined cycle is the cycle aimed at further higher efficiency and higher environmental performance compared with conventional type of coal-fired power generation by gasifying coal and combining it with combined cycle power generation. This integrated coal gasification combined cycle has a great advantage of also being able to utilize coal as an abundant amount of resource, and it has been known that the advantage becomes greater by extending applicable coal types.

A conventional integrated coal gasification combined cycle generally has: a coal feed apparatus; a coal gasifier; a char recovery apparatus; gas purification equipment; gas turbine equipment; steam turbine equipment; and a heat recovery steam generator. Accordingly, coal (pulverized coal) is fed to the coal gasifier by the coal feed apparatus and also, gasifying agents (air, oxygen-enriched air, oxygen, steam, etc.) are taken in, coal is burned and gasified in the coal gasifier, and syngas (combustible gas) is generated. Gas purification of the syngas is then performed after unburned coal (char) is removed in the char recovery apparatus, the purified syngas is burned by being fed to the gas turbine equipment, high-temperature and high-pressure combustion gas is generated, and a turbine is driven. Heat energy of exhaust gas emitted by driving of the turbine is recovered by the heat recovery steam generator, steam is generated to be fed to the steam turbine equipment, and a turbine is driven. As a result of this, power generation is performed. Meanwhile, the exhaust gas whose heat energy has been recovered is emitted to the atmosphere through a funnel.

The char recovery apparatus in the above-mentioned integrated coal gasification combined cycle removes from the syngas generated in the coal gasifier char contained therein using plural stages of dust collecting devices. The recovered char is then returned to the coal gasifier by each predetermined amount by a char feed apparatus. That is, a bin system is applied here. A general bin system has: one (or a plurality of) bin(s); a plurality of char discharge lines that discharge into the bin(s) char recovered by each dust collecting device; and a plurality of char feed lines that feed the char recovered in the bin(s) to a plurality of (or one) hopper(s).

It is to be noted that there are included char recovery apparatuses described in the following PTLs 1 to 3 as conventional ones.

### CITATION LIST

### Patent Literature

{PTL 1}

Japanese Patent No. 3054788

{PTL 2}

Japanese Patent No. 3652848

{PTL 3}

Japanese Unexamined Patent Application, Publication No. 2006-063098

### SUMMARY OF INVENTION

### Technical Problem

When a plurality of char discharge lines are coupled to each other at an upper part of one bin, or a plurality of char feed lines are coupled to each other at a lower part of the one bin, a plurality of dust collecting devices and a plurality of hoppers are arranged side by side in a horizontal direction. From this, the char discharge lines and the char feed lines are arranged at a predetermined inclination angle to a vertical direction from the dust collecting devices and the hoppers toward the bin. In the above-mentioned char recovery apparatus, char transfer is performed as dry conveyance, and the char transfer from the dust collecting devices to the hoppers through the bin is performed by means of gravitational fall. In this case, when the inclination angles of the char discharge lines and the char feed lines are set to be large, there is a possibility that char within piping may accumulate. Therefore, the inclination angles of the char discharge lines and the char feed lines cannot be made small, the char discharge lines and the char feed lines become long in consideration of mutual interference of the plurality of dust collecting devices and the plurality of hoppers, and there is a problem of causing longitudinal shapes of a bin system and the char recovery apparatus, i.e., causing increase in size and high cost of the apparatus.

The present invention solves the above-mentioned problems, and an object thereof is to provide a bin system and a char recovery apparatus that can achieve reduction in size of the apparatus.

### Solution to Problem

A bin system pertaining to a first aspect of the present invention for achieving the above-described object includes: a closed container in which powder can be collected or stored; a plurality of powder discharge lines that are arranged at a predetermined inclination angle at which the powder can be discharged in the closed container by means of gravitational fall; a plurality of powder feed lines that are arranged at a predetermined inclination angle at which the powder stored in the closed container can be fed by means of the gravitational fall; and an assist device that assists flow of the powder gravitationally falling down the plurality of powder discharge lines.

Accordingly, when the powder flows through each powder discharge line by means of the gravitational fall to be discharged in the closed container, and flows through each of the powder feed lines by means of the gravitational fall from the closed container, the assist device assists the flow of the powder that gravitationally falls down the plurality of powder discharge lines. From this, the powder properly flows through these powder discharge lines, and accumulation of the powder can be suppressed. As a result of it, it becomes possible to set large the inclination angle of the plurality of powder discharge lines and to suppress a height of the apparatus, and thus reduction in size of the apparatus can be achieved.

A bin system pertaining to a second aspect of the present invention includes: a closed container in which powder can be collected or stored; a plurality of powder discharge lines that are arranged at a predetermined inclination angle at which the powder can be discharged in the closed container by means of gravitational fall; a plurality of powder feed lines that are arranged at a predetermined inclination angle at which the powder stored in the closed container can be fed by means of the gravitational fall; and an assist device that assists flow of the powder gravitationally falling down the plurality of powder feed lines.

Accordingly, when the powder flows through each of the powder discharge lines by means of the gravitational fall to be discharged in the closed container, and flows through each of the powder feed lines by means of the gravitational fall from the closed container, the assist device assists the flow of the powder that gravitationally falls down the plurality of powder feed lines. From this, the powder properly flows through these powder feed lines, and accumulation of the powder can be suppressed. As a result of it, it becomes possible to set large the inclination angle of the plurality of powder feed lines and to suppress a height of the apparatus, and thus reduction in size of the apparatus can be achieved.

In the bin system pertaining to the first aspect or the second aspect, the assist device may be configured to have an assist gas feed device that feeds inactive gas (N₂, CO₂, etc.) along a flow direction of the powder.

Accordingly, simplification of the apparatus can be achieved by applying as the assist device the assist gas feed device that feeds the inactive gas and also, a proper powder conveyance system can be constructed without adversely affecting the powder that flows through each line.

In the bin system pertaining to the configuration, the assist gas feed device may feed the inactive gas along an inner peripheral lower surface in piping included in the powder discharge line or the powder feed line.

Accordingly, although the powder moves along the inner peripheral lower surface in the piping included in the powder discharge line or the powder feed line, the inactive gas is fed along the inner peripheral lower surface in this piping, thereby flow of the powder becomes smooth, and accumulation of the powder inside the piping can be prevented.

In the bin system pertaining to the configuration, in the assist gas feed device, an assist gas chamber may be provided at a lower part of the piping included in the powder discharge line or the powder feed line, and the inactive gas may be fed to the inner peripheral lower surface in the piping from the assist gas chamber.

Accordingly, the inactive gas is fed to the inner peripheral lower surface of the piping from the assist gas chamber provided at the lower part of the piping included in the powder discharge line or the powder feed line, thereby the powder that flows along the inner peripheral lower surface in the piping flows smoothly due to the inactive gas, and accumulation of the powder inside the piping can be prevented.

In the bin system pertaining to the configuration, the assist gas feed device may change a feed amount of the inactive gas according to a flow rate of the powder.

Accordingly, a proper amount of inactive gas is fed according to the flow rate of the powder, thereby a conveyance speed of the powder can be maintained at a proper speed and also, usage of the inactive gas can be reduced to reduce operation cost.

In the bin system pertaining to the first aspect or the second aspect, the inclination angle of the powder discharge line or the powder feed line is set to be not more than 60 degrees with respect to a horizontal direction, and the assist device may be provided at the line set to have the inclination angle not more than 60 degrees.

Accordingly, the inclination angles of the powder discharge line and the powder feed line can be set to be not more than 60 degrees, it becomes possible to suppress the height of the apparatus, and reduction in size of the apparatus can be achieved.

The bin system pertaining to the first aspect or the second aspect may be configured such that the inclination angle of the powder discharge line or the powder feed line is set to be not more than 60 degrees with respect to the horizontal direction, the assist device is provided at the line set to have the inclination angle not more than 60 degrees and that also, an assist gas discharge part connected to an inlet side of a dust collecting device from the assist device is provided.

Accordingly, the inclination angles of the powder discharge line and the powder feed line can be set to be not more than 60 degrees, it becomes possible to suppress the height of the apparatus, and the assist device and the assist gas discharge part are provided at the line, whereby further reduction in size of the apparatuses can be achieved.

Additionally, the assist gas discharge part is connected to the inlet side of the dust collecting device, and thereby the powder contained in exhaust gas of the assist gas can be recovered by the dust collecting device.

In the above-described configuration, the dust collecting device may separate unburned coal from syngas generated by gasifying the coal, and an assist gas input amount may be set so that an exhaust gas flow rate of the assist gas is not more than 10% of a syngas flow rate, hereby dilution of the syngas due to the assist gas is suppressed to the minimum. Adjustment of the assist gas input amount can be achieved by setting a passage sectional area or an assist gas input flow velocity of the assist gas input part.

Accordingly, since decreasing rate of calorie of the syngas is suppressed to not more than 10% in an integrated coal gasification combined cycle in which syngas is used as gas turbine fuel, combustion of a gas turbine combustion device can be stabilized, and deterioration of product purity can be prevented in a chemical fuel plant having a coal gasifier.

Further, a char recovery apparatus pertaining to a third aspect of the present invention is the char recovery apparatus that recovers unburned coal from syngas generated by gasifying coal, and includes: a first dust collecting device that is coupled to a syngas generation line; a second dust collecting device that is coupled to a first gas discharge line in the first dust collecting device; a bin that is coupled to a first unburned coal discharge line in the first dust collecting device and a second unburned coal discharge line in the second dust collecting device; a plurality of unburned coal feed lines that feed unburned coal to an unburned coal return line from the bin; and an assist device that assists flow of the unburned coal gravitationally falling down each of the unburned coal discharge lines or each of the unburned coal feed lines.

Accordingly, coarse-grained unburned coal is separated from the syngas by the first dust collecting device, fine-grained unburned coal is separated from the syngas by the second dust collecting device, the unburned coal is stored in the bin through each unburned coal discharge line, and the unburned coal stored in the bin is fed to the unburned coal return line through each of the unburned coal feed lines. At this time, since the assist device assists the flow of the unburned coal that gravitationally falls down each of the unburned coal discharge lines or each of the unburned coal feed lines, the unburned coal properly flows through these unburned coal discharge line and unburned coal feed line, and accumulation thereof can be suppressed. As a result of it, it becomes possible to set large an inclination angle of the plurality of unburned coal discharge lines and unburned coal feed line and to suppress a height of the apparatus, and thus reduction in size of the apparatus can be achieved.

### Advantageous Effects of Invention

According to the bin system and the char recovery apparatus of the present invention, since the assist device that assists the flow of the powder gravitationally falling down a powder conveyance line is provided, reduction in size of the apparatus can be achieved.

### BRIEF DESCRIPTION OF DRAWINGS

{FIG. 1}

FIG. 1 is a schematic configuration diagram of an integrated coal gasification combined cycle to which a bin system pertaining to Example 1 of the present invention has been applied.

{FIG. 2}

FIG. 2 is a schematic diagram showing a main portion of the bin system of Example 1.

{FIG. 3}

FIG. 3 is a schematic configuration diagram showing a main portion of a bin system pertaining to Example 2 of the present invention.

{FIG. 4}

FIG. 4 is a schematic configuration diagram showing a main portion of a bin system pertaining to Example 3 of the present invention.

{FIG. 5}

FIG. 5 is a schematic configuration diagram showing a main portion of a bin system pertaining to Example 4 of the present invention.

{FIG. 6}

FIG. 6 is a schematic configuration diagram showing a main portion of a bin system including an assist gas discharge part connected to an inlet side of a dust collecting device from an assist device.

{FIG. 7A}

FIG. 7A is an explanatory diagram of assist gas flow rate decision, and is also a schematic diagram showing an assist device of FIG. 4.

{FIG. 7B}

FIG. 7B is an explanatory diagram of the assist gas flow rate decision, and is also a cross-sectional view of FIG. 7A.

### DESCRIPTION OF EMBODIMENTS

Hereinafter, preferred Examples of a bin system and a char recovery apparatus pertaining to the present invention will be explained in detail with reference to accompanying drawings. It is to be noted that the present invention is not limited by the Examples, and that when there are a plurality of Examples, configurations of combinations of each Example are also included.

### Example 1

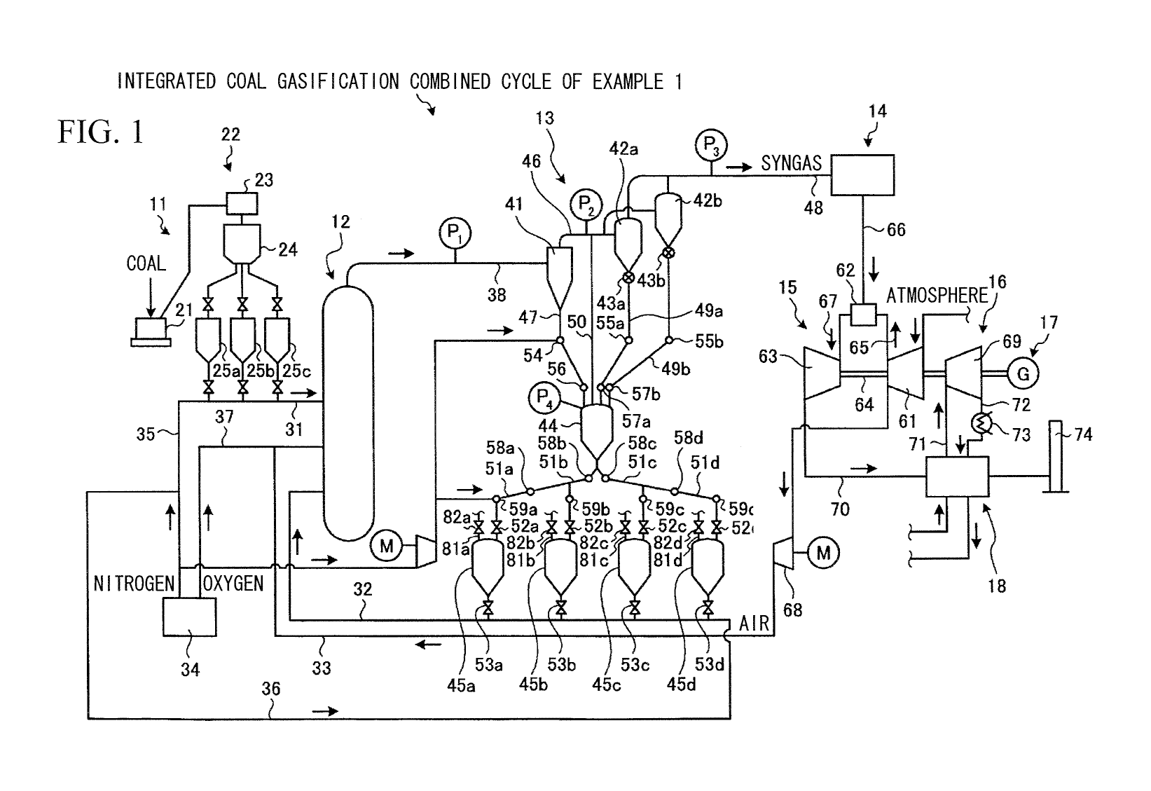

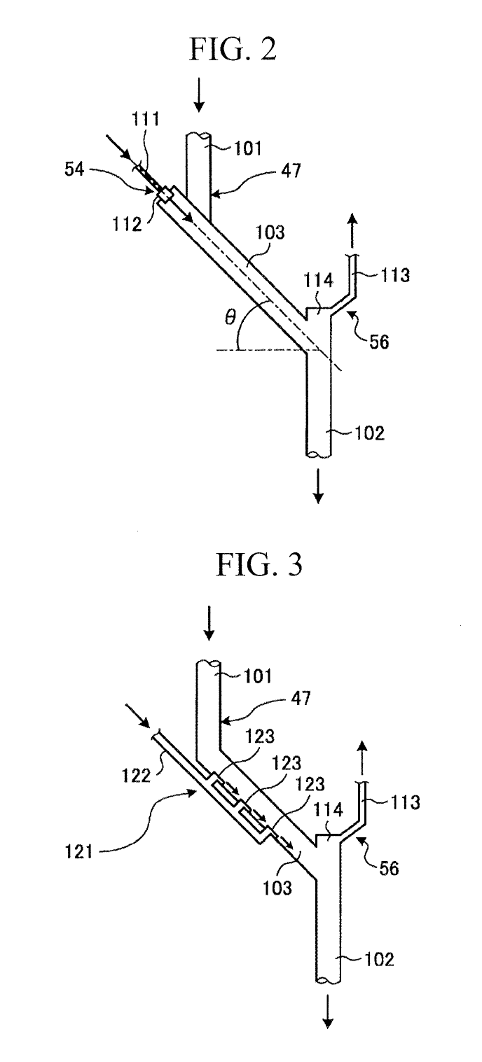

FIG. 1 is a schematic configuration diagram of an integrated coal gasification combined cycle to which a bin system pertaining to Example 1 of the present invention has been applied, and FIG. 2 is a schematic diagram showing a main portion of the bin system of Example 1.

An IGCC (Integrated Coal Gasification Combined Cycle) of Example 1 employs an air-blown scheme in which coal gas is generated in a gasifier by using the air as a gasifying agent, and it feeds coal gas obtained by being purified in gas purification equipment to gas turbine equipment as fuel gas to thereby generate electricity. That is, the IGCC of this Example is the cycle with the air-blown scheme.

The IGCC of Example 1, as shown in FIG. 1, has: a coal feed apparatus 11; a coal gasifier 12; a char recovery apparatus 13; gas purification equipment 14; gas turbine equipment 15; steam turbine equipment 16; a generator 17; and an HRSG (Heat Recovery Steam Generator) 18.

The coal feed apparatus 11 has: a coal pulverizer (mill) 21; and pulverized coal feed equipment (a bin system) 22 that pressurizes and feeds pulverized coal having been dried and pulverized by the coal pulverizer 21. The coal pulverizer 21 pulverizes coal into fine particles while drying it by means of dry gas, and manufactures pulverized coal. In this case, a part of exhaust gas from the gas turbine equipment 15 and the heat recovery steam generator 18 is utilized as gas for drying. Additionally, a pulverized coal separation device (for example, a dust collector) 23; a pulverized coal bin 24; and a plurality of pulverized coal feed hoppers 25a, 25b, and 25c are provided on a downstream side of the coal pulverizer 21 as the pulverized coal feed equipment 22.

A coal feed line 31 is connected to the coal gasifier 12 from the pulverized coal feed equipment, and pulverized coal can be fed to the coal gasifier 12. In addition, a char return line 32 is connected to the coal gasifier 12 from the char recovery apparatus 13, and char (unburned coal, powder) recovered by the char recovery apparatus 13 can be recycled.

Furthermore, a compressed air feed line 33 is connected to the coal gasifier 12 from the gas turbine equipment 15 (a compressor 61), and a part of the air compressed by the gas turbine equipment 15 is boosted by a bleed air booster and can be fed to the coal gasifier 12. An air separation device 34 separates and generates nitrogen and oxygen from the air in the atmosphere, a first nitrogen feed line 35 is connected to the coal feed line 31 and also, a second nitrogen feed line 36 is connected to the char return line 32, and an oxygen feed line 37 is connected to the compressed air feed line 33. In this case, nitrogen is utilized as gas for conveying coal and char, and oxygen is utilized as a gasifying agent.

The coal gasifier 12 is, for example, an entrained-bed-type gasifier, performs partial oxidation and gasification of coal (pulverized coal) fed to an inside thereof by means of a gasifying agent (air, oxygen-enriched air, oxygen, steam, etc.), and thereby generates combustible gas (syngas, coal gas) that contains carbon dioxide and hydrogen as main components. It is to be noted that the coal gasifier 12 is not limited to an entrained-bed-type gasifier, and may be a fluidized-bed gasifier or a fixed-bed gasifier. Additionally, a syngas line 38 is provided at a subsequent stream of the coal gasifier 12, and is connected to the char recovery apparatus 13. Char contained in the syngas and the syngas can be separated from each other by the same char recovery apparatus 13. In this case, a gas cooling device at the subsequent stream of the gasifier is provided, and after being cooled to a predetermined temperature, the combustible gas may be fed to the char recovery apparatus 13 through the syngas line 38.

The bin system of the present invention is applied to the char recovery apparatus 13, and the char recovery apparatus 13 has: a cyclone 41 as a first dust collecting device; a first filter 42a and a second filter 42b as second dust collecting devices; respective rotary valves 43a and 43b; a bin 44; and hoppers 45a, 45b, 45c, and 45d. The cyclone 41 primarily separates char (separates coarse grains) contained in the combustible gas generated in the coal gasifier 12, and a first gas discharge line 46 that discharges combustible gas from which coarse-grained char has been separated is connected to an upper part of the cyclone 41 and also, a first char discharge line (first unburned coal discharge line) 47 that discharges the coarse-grained char separated from the combustible gas is connected to a lower part of the cyclone 41.

The branched first gas discharge lines 46 are connected at sides of the first and second filters 42a and 42b, respectively, and a second gas discharge line 48 that discharges combustible gas from which fine-grained char has been separated is connected to upper parts of the first and second filters 42a and 42b and also, second char discharge lines 49a and 49b that discharge the fine-grained char separated from the combustible gas are connected to lower parts of the first and second filters 42a and 42b. The rotary valves 43a and 43b are provided at discharge parts to the second char discharge lines 49a and 49b in the respective filters 42a and 42b, respectively. These filters 42a and 42b are porous filters and, for example, has a filter medium made of ceramics, and the char in the combustible gas can be removed when the combustible gas passes through the filter medium. The char collected by these filters 42a and 42b then falls by backwash treatment etc., is discharged from filter containers by means of the rotary valves 43a and 43b, and is cleared out to the bin 44 through the second char discharge lines 49a and 49b.

Additionally, a first pressure equalizing line 50 that equalizes pressures of both the first gas discharge line 46 and the bin 44 is provided therebetween.

Downstream ends of the first char discharge line 47 and the second char discharge lines 49a and 49b are connected to the bin 44, and the bin 44 collects the coarse-grained char and the fine-grained char that have been separated from the combustible gas by the cyclone 41 and the first and second filters 42a and 42b to distribute to each hopper. Each of the hoppers 45a, 45b, 45c, and 45d are connected to the bin 44 through switching lines 51a, 51b, 51c, and 51d, first switching valves 52a, 52b, 52c, and 52d are mounted at these switching lines 51a, 51b, 51c, and 51d on upstream sides of the hoppers 45a, 45b 45c, and 45d, and second switching valves 53a, 53b, 53c, and 53d are mounted at the switching lines 51a, 51b, 51c, and 51d on downstream sides of the hoppers 45a, 45b 45c, and 45d.

That is, the switching lines 51a, 51b, 51c, and 51d to be used are switched by the respective switching valves 52a, 52b, 52c, 52d, 53a, 53b, 53c, and 53d, thereby the hoppers 45a, 45b, 45c, and 45d are alternately used, and continuous operation can be achieved. Additionally, the switching lines 51a, 51b, 51c, and 51d join on the downstream sides of the hoppers 45a, 45b 45c, and 45d, and are connected to the char return line 32. In this case, in this Example, for the four switching lines 51a, 51b, 51c, and 51d (four hoppers 45a, 45b, 45c, and 45d), the bin 44 is arranged on the upstream sides thereof, and the bin 44 in which char is collected, distributed to each hopper, and temporarily stored is provided.

Additionally, between the first gas discharge line 46 and the hoppers 45a, 45b, 45c, and 45d of the cyclone, a pressure equalizing line 81a (81b, 81c, 81d) that finishes a state of feeding char to the gasifier (for example, in a case of the hopper 45a, a state where the switching valve 52a is a closed state, the switching valve 53a is an opened state, and a pressure of the hopper 45a is higher than that of the bin 44), and evacuates gas in the hopper 45a to equalize the pressure in order to receive the char of the bin 44 is provided. The pressure equalizing line 81a (81b, 81c, 81d) is connected to the first gas discharge line 46, and third switching valves 82a, 82b, 82c, and 82d are mounted at the pressure equalizing line 81a (81b, 81c, 81d).

As described above, the char recovery apparatus 13 of this Example includes: the cyclone 41; the first filter 42a and the second filter 42b; the rotary valves 43a and 43b; the bin 44; the hoppers 45a, 45b, 45c, and 45d; etc., and the bin system of the present invention includes: the bin 44 as a container in which char can be collected, distributed to each hopper, and stored; the char discharge lines 47, 49a, and 49b as a plurality of powder discharge lines that are arranged at a predetermined inclination angle at which the char can be discharged in the bin 44 by means of gravitational fall; the switching lines 51a, 51b, 51c, and 51d as a plurality of powder feed lines that are arranged at a predetermined inclination angle at which the char collected in the bin 44 or the char stored therein can be fed to the hoppers 45a, 45b, 45c, and 45d by means of the gravitational fall; etc. Additionally, in this Example, as assist devices that assist flow of the char gravitationally falling down, assist gas feed devices that feed inactive gas along flow directions of the char are provided at the respective char discharge lines 47, 49a, and 49b and the respective switching lines 51a, 51b, 51c, and 51d.

In this Example, the assist gas feed devices mounted at the respective char discharge lines 47, 49a, and 49b have assist gas feed parts 54, 55a, and 55b and assist gas discharge parts 56, 57a, and 57b, respectively. In addition, the assist gas feed devices mounted at the respective switching lines 51a, 51b, 51c, and 51d have assist gas feed parts 58a, 58b, 58c, and 58d and assist gas discharge parts 59a, 59b, 59c, and 59d, respectively.

Here, substantially similarly configured are: the assist gas feed parts 54, 55a, and 55b and the assist gas discharge parts 56, 57a, and 57b as the assist gas feed devices of the respective char discharge lines 47, 49a, and 49b; and the assist gas feed parts 58a, 58b, 58c, and 58d and the assist gas discharge parts 59a, 59b, 59c, and 59d as the assist gas feed devices of the respective switching lines 51a, 51b, 51c, and 51d. Therefore, hereinafter, explained will be only the assist gas feed part 54 and the assist gas discharge part 56 as the assist gas feed devices of the first char discharge line 47.

In the assist gas feed device, as shown in FIG. 2, the first char discharge line 47 includes: a first linear part 101 that is arranged hanging down in a vertical direction from the cyclone 41 (refer to FIG. 1); a second linear part 102 that is arranged hanging down in the vertical direction to the bin 44 (refer to FIG. 1); and an inclination part 103 that couples a lower end of the first linear part 101 and an upper end of the second linear part 102 to each other. In this case, the inclination part 103 is arranged so as to incline in a horizontal direction by a predetermined angle θ (for example, not more than 60 degrees).

Additionally, in the inclination part 103 of the char discharge line 47, the assist gas feed part 54 is mounted at a base end (upper end), and the assist gas discharge part 56 is mounted at a tip (lower end). The assist gas discharge part 56 is connected to an inlet (upstream) side of any one of the dust collecting devices, such as the cyclone 41, the first filter 42a, and the second filter 42b.

The assist gas feed part 54 has: a gas feed pipe 111 through which inactive gas is fed; and a gas injection nozzle 112, and the gas injection nozzle 112 can feed the inactive gas from the base end of the inclination part 103 to an inside thereof.

The assist gas discharge part 56 has: a gas discharge pipe 113 through which substitution gas corresponding to a volume due to movement of the char and inactive gas are discharged; and a gas recovery part 114, and the gas recovery part 114 can discharge internal gas from the tip end of the inclination part 103.

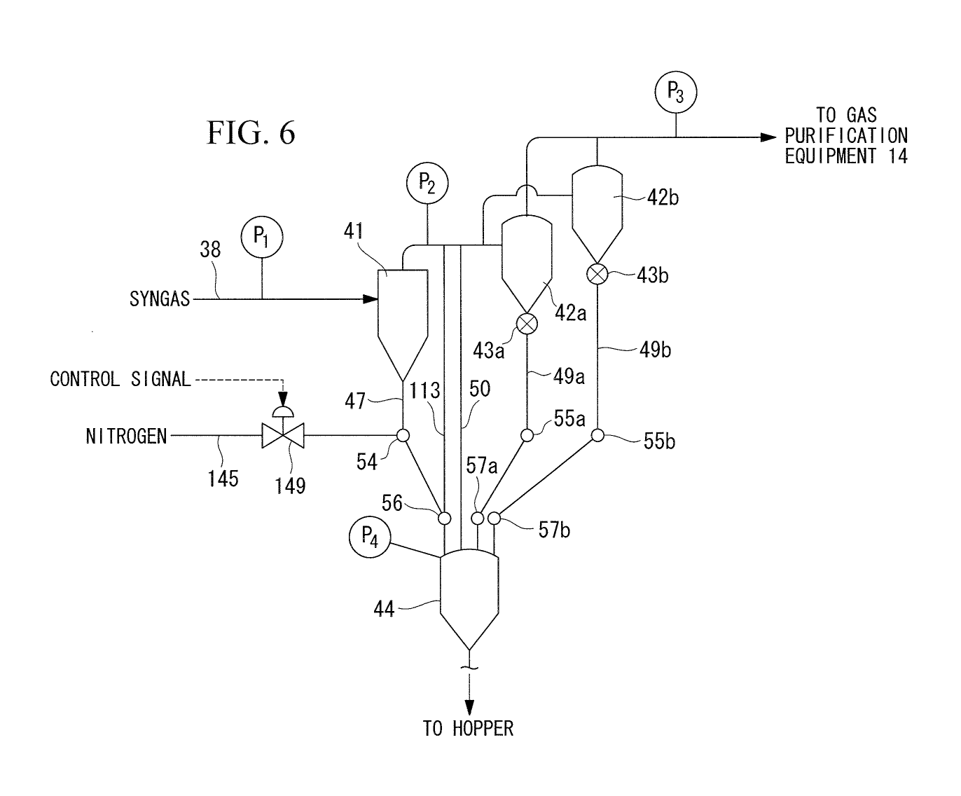

The gas recovery part 114 has a function to separate the char from the gas, and specifically, it has a structure to be opened in an opposite direction (upper side of the second linear part 102) of a char discharge direction, and to gravitationally separate or inertially separate the char and the gas. In a configuration example of this Example, the gas discharge pipe 113 of the assist gas discharge part 56 is, for example, as shown in FIG. 6, connected to an inlet (upstream) side of the first filter 42a, which is the dust collecting device. It is to be noted that although illustration of gas discharge pipes of the assist gas discharge parts 57a and 57b is omitted in the configuration example shown in FIG. 6, they are still connected to inlet sides of the dust collecting devices.

In this case, although nitrogen gas and carbon dioxide gas are desirably used as the inactive gas, inactive gas (inert gas) whose oxygen concentration is not more than 3%, or combustible gas (gas obtained by boosting and recycling outlet gas of the char recovery apparatus or the gas purification equipment) may just be used, and combustion of the gas that flows through the first char discharge line 47 can be prevented. In addition, it is desirable for the inactive gas to be gas with a temperature not less than a dew point of the gas that flows through the first char discharge line 47. Additionally, the assist gas feed part 54 feeds the inactive gas continuously or intermittently.

Accordingly, the coarse-grained char separated from the combustible gas by the cyclone 41 flows down the first char discharge line 47 by means of gravitational fall, is collected in the bin 44 through the first linear part 101, the inclination part 103, and the second linear part 102, and is distributed to each hopper or stored in the bin 44. At this time, since in the assist gas feed part 54, the inactive gas is fed in the inclination part 103 from the gas injection nozzle 112 toward a flow direction of the coarse-grained char, flow of the coarse-grained char that moves along an inner lower surface of piping included in the first char discharge line 47 is promoted, and accumulation of the coarse-grained char can be suppressed.

Additionally, in the assist gas discharge part 56, the gas recovery part 114 can recover the substitution gas corresponding to the volume due to the movement of the char and the fed inactive gas. Since the gas discharge pipe 113 of the assist gas discharge part 56 is connected to the inlet side of the first filter 42a provided as the dust collecting device, powder, such as char, contained in the inactive gas recovered as used exhaust gas, can also be recovered by the first filter 42a.

The gas purification equipment 14 removes impurities, such as a sulfur compound, a nitrogen compound, a halide, from the combustible gas from which the char has been separated by the char recovery apparatus 13, and thereby performs gas purification. Additionally, the gas purification equipment 14 removes impurities from the combustible gas to manufacture fuel gas, and feeds it to the gas turbine equipment 15.

The gas turbine equipment 15 has: the compressor 61; a combustor 62; and a turbine 63, and the compressor 61 and the turbine 63 are coupled to each other by a rotational shaft 64. A compressed air 65 is fed to the combustor 62 from the compressor 61 and also, fuel gas 66 is fed to the combustor 62 from the gas purification equipment 14, and the combustor 62 feeds combustion gas 67 to the turbine 63. In addition, the compressed air feed line 33 that extends from the compressor 61 to the coal gasifier 12 is provided at the gas turbine equipment 15, and a booster 68 is provided in an intermediate portion thereof. Accordingly, in the combustor 62, the compressed air fed from the compressor 61 and the fuel gas fed from the gas purification equipment 14 are mixed and burned, and in the turbine 63, the generator 17 can be driven by rotating the rotational shaft 64 by means of the generated combustion gas.

The steam turbine equipment 16 has a turbine 69 coupled to the rotational shaft 64 in the gas turbine equipment 15, and the generator 17 is coupled to a base end of the rotational shaft 64. The heat recovery steam generator 18 is provided at an exhaust gas line 70 from the gas turbine equipment 15 (turbine 63), and generates steam by performing heat exchange with high-temperature exhaust gas. The exhaust gas whose heat has been recovered by the heat recovery steam generator 18 is emitted to the atmosphere from a funnel 74.

Here, actuation of the IGCC of Example 1 will be explained.

In the IGCC of Example 1, as shown in FIG. 1, in the coal feed apparatus 11, coal is dried and ground by the coal pulverizer 22, and pulverized coal is manufactured. The pulverized coal is pressurized by the pulverized coal separation device and a pulverized coal bin, and the pulverized coal feed equipment (bin system) including the pulverized coal, and is fed to the coal gasifier 12 through the coal feed line 31 by means of nitrogen fed from the air separation device 34. In addition, the char recovered by the char recovery apparatus 13, which will be mentioned later, is fed to the coal gasifier 12 through the char return line 32 by means of nitrogen fed from the air separation device 34. Furthermore, after compressed air bled from the gas turbine equipment 15, which will be mentioned later, is boosted by the booster 68, the boosted air is fed to the coal gasifier 12 through the compressed air feed line 33 together with oxygen fed from the air separation device 34.

The fed pulverized coal is partially oxidized and gasified by a gasifying agent (a compressed air, oxygen, etc.), and thereby the coal gasifier 12 generates combustible gas (syngas, coal gas) that contains carbon dioxide and hydrogen as main components. The combustible gas is then discharged through the syngas line 38 from the coal gasifier 12, and is fed to the char recovery apparatus 13.

In the char recovery apparatus 13, the combustible gas is first fed to the cyclone 41, and thereby the char contained in the combustible gas is here primarily separated (coarse grains are separated) from the combustible gas. While the combustible gas from which the char has been primarily separated is then discharged to the first gas discharge line 46, the coarse-grained char separated from the combustible gas is cleared out to the bin 44 through the first char discharge line 47.

The combustible gas from which the char has been primarily separated by the cyclone 41, and that has been discharged to the first gas discharge line 46 is next fed to the respective filters 42a and 42b, and char that remains in the combustible gas is secondarily separated.

While the combustible gas from which the remaining char has been secondarily separated is then discharged to the second gas discharge line 48, the char separated from the combustible gas is discharged from a filter container by the rotary valves 43a and 43b, and is cleared out to the bin 44 through the second char discharge lines 49a and 49b. Here, the bins 44 collects the primarily separated char that is cleared out to the bin 44 through the first char discharge line 47, and the secondarily separated char that is cleared out to the bin 44 through the second char discharge lines 49a and 49b, and can separate and feed them into/to each hopper or store them.

In this case, assuming that a pressure of the syngas line 38 is P1, a pressure of the first gas discharge line 46 is P2, and a pressure of the second gas discharge line 48 is P3, a pressure relation thereof is expressed by P1>P2>P3. In addition, the first pressure equalizing line 50 is provided between the first gas discharge line 46 and the bin 44, thereby the pressure P2 of the first gas discharge line 46 and the pressure P4 of the bin 44 become substantially the same as each other, and a pressure relation thereof is expressed by P1>P4≈P2>P3.

Therefore, the primarily separated char separated by the cyclone 41 is cleared out to the bin 44 from the first char discharge line 47, backflow of the gas containing the coarse-grained char in the first char discharge line 47 is prevented, and a dust collection efficiency of the cyclone 41 can be maintained high. If the first pressure equalizing line 50 does not exist, the gas replaced by a volume of the primarily separated char flows backward through the first char discharge line 47, and when a discharge amount of the primarily separated char increases, a phenomenon occurs in which the primarily separated char blows up at a discharge part (throat part) of the cyclone 41, and the dust collection efficiency in the cyclone 41 decreases.

It is to be noted that since the char is cleared out from the cyclone 41 and the filters 42a and 42b to the bin 44 through each of the char discharge lines 47, 49a, and 49b although the pressure P2 of the first gas discharge line 46 and the pressure P4 of the bin 44 are adjusted substantially the same as each other by the first pressure equalizing line 50, the gas containing the char in the bin 44 may be emitted to the first gas discharge line 46 through the first pressure equalizing line 50, and thus the char is separated from the combustible gas by the emitted gas from the first pressure equalizing line 50 being fed to the respective filters 42a and 42b.

In addition, the primarily separated char separated from the combustible gas by the cyclone 41 is cleared out to the bin 44 through the first char discharge line 47, and also, the secondarily separated char separated from the combustible gas by the respective filters 42a and 42b is cleared out to the bin 44 through the second char discharge lines 49a and 49b.

At this time, as shown in FIGS. 1 and 2, the assist gas feed parts 54, 55a, and 55b of the assist gas feed device feed inactive gas to the inclination parts 103 of the respective char discharge lines 47, 49a, and 49b, and they assist flow of the coarse-grained char that moves along the lower surface in the piping included in the respective char discharge lines 47, 49a, and 49b, whereby the flow is promoted, and accumulation of the char in the piping can be suppressed.

After that, substitution gas corresponding to a volume due to the movement of the char and inactive gas are discharged by the assist gas discharge part 56 on downstream sides of the inclination parts 103 of the respective char discharge lines 47, 49a, and 49b, thereby back pressure rise in the respective char discharge lines 47 and 49a and 49b is suppressed, and stable discharge of the char can be maintained.

Since the assist gas discharged by the assist gas discharge part 56 is guided to the inlet side of the first filter 42a through the gas discharge pipe 113, and joins flow of the syngas, the char contained in the inactive gas recovered as used exhaust gas can also be recovered by the first filter 42a.

Additionally, as for the char collected or stored in the bin 44, the first switching valves 52a, 52b, 52c, and 52d and the second switching valves 53a, 53b, 53c, and 53d, and third switching valves 90a, 90b, 90c, and 90d are sequentially opened and closed, and thereby the switching line 51a and the hopper 45a, the switching line 51b and the hopper 45b, the switching line 51c and the hopper 45c, and the switching line 51d and the hopper 45d are used in order. For example, when the char is fed to the hopper 45a from the bin 44, the third switching valve 90a of a second pressure equalizing line 60a and the switching valve 52a of the switching line 51a are opened, the switching valve 53a is closed, and thereby pressures of the bin 44 and the hopper 45a are equalized, and the char can be fed. At this time, assuming that the hopper 45c is used as the hopper that feeds the char to the gasifier, the third switching valve 90c of the second pressure equalizing line 60c, and the switching valve 52c of the switching line 51c are closed, the switching valve 53c is opened, and the char can be returned to the gasifier. The other switching valves 90b and 90d are opened, switching valves 52b, 52d, 53b, and 53d are closed, and thereby the char of the bin 44 can be fed to the hopper 45a by the switching line 51a. Additionally, if the hopper 45a is filled, the third switching valve 90b of the second pressure equalizing line 60b and the switching valve 52b of the switching line 51b are opened, the switching valve 53b is closed, and thereby pressures of the bin 44 and the hopper 45b are equalized, and the char can be fed. As a result of this, discharge and feed work of the recovered char from the bin to the hopper can be performed continuously, and continuous operation of the char recovery apparatus 13 can be achieved. The char fed to the hoppers 45a, 45b, 45c, and 45d is returned to the coal gasifier 12 through the char return line 32, and is gasified.

At this time, the assist gas feed parts 58a, 58b, 58c, and 58d of the assist gas feed device feed inactive gas to the inclination parts at the time of char feed of the respective switching lines 51a, 51b, 51c, and 51d, and they assist flow of the char that moves along the lower surface in piping included in the respective switching lines 51a, 51b, 51c, and 51d, whereby the flow is promoted, and accumulation of the char in the piping can be suppressed. After that, substitution gas corresponding to a volume by the movement of the char and inactive gas are discharged by the assist gas discharge parts 59a, 59b, 59c, and 59d on downstream sides of inclination parts of the respective switching lines 51a, 51b, 51c, and 51d, thereby back pressure rise in the respective switching lines 51a, 51b, and 51c and 51d is suppressed, and stable discharge of the char can be maintained. It is to be noted that the assist gas discharge parts 59a, 59b, 59c, and 59d are also connected to the inlet side of any one of the dust collecting devices, such as the cyclone 41, the first filter 42a, and the second filter 42b.

Impurities, such as a sulfur compound, a nitrogen compound, a halide, are removed from the combustible gas from which the char has been separated by the char recovery apparatus 13 in the gas purification equipment 14, and fuel gas is manufactured. Additionally, in the gas turbine equipment 15, the compressor 61 compresses the air, feeds it to the combustor 62, combustion gas is generated in the combustor 62 by burning the compressed air fed from the compressor 61 and the fuel gas fed from the gas purification equipment 14, and the turbine 63 is driven by means of the combustion gas, whereby the generator 17 can be driven through the rotational shaft 64 to generate electricity.

Additionally, steam is generated from exhaust gas discharged from the turbine 63 in the gas turbine equipment 15 by performing heat exchange in the heat recovery steam generator 18, and the generated steam is fed to the steam turbine equipment 16. In the steam turbine equipment 16, the turbine 69 is driven by means of the steam fed from the heat recovery steam generator 18, and thereby the generator 17 can be driven through the rotational shaft 64 to generate electricity.

The exhaust gas discharged from the heat recovery steam generator 18 is emitted to the atmosphere from the funnel 74.

As described above, in the bin system of Example 1, provided are: the bin 44 that can collect and distribute or store char; the three char discharge lines 47, 49a, and 49b that are arranged at the predetermined inclination angle θ at which the char can be discharged in the bin 44 by means of gravitational fall; the four switching lines 51a, 51b, 51c, and 51d that are arranged at the predetermined inclination angle θ at which the char collected or stored in the bin 44 can be fed by means of the gravitational fall; and the assist gas feed parts 54, 55a, 55b, 58a, 58b, 58c, and 58d as the assist devices that assist flow of the char gravitationally falling down the char discharge lines 47, 49a, and 49b.

Accordingly, when the char flows through the respective char discharge lines 47, 49a, and 49b and is discharged in the bin 44 by means of the gravitational fall, the assist gas feed parts 54, 55a, and 55b assist the flow of the char that gravitationally falls down the respective char discharge lines 47, 49a, and 49b, so that the char properly flows through the respective char discharge lines 47, 49a, and 49b, and that accumulation in the piping included in the respective char discharge lines 47, 49a, and 49b can be suppressed. As a result of it, it becomes possible to set large the inclination angle of the respective char discharge lines 47, 49a, and 49b and to suppress a height of the apparatus, and reduction in size of the apparatus can be achieved.

In addition, in the bin system of Example 1, the assist gas feed parts 58a, 58b, 58c, and 58d are provided as the assist devices that assist flow of the char gravitationally falling down the respective switching lines 51a, 51b, 51c, and 51d. Accordingly, since the assist gas feed parts 58a, 58b, 58c, and 58d assist the flow of the char that gravitationally falls down the respective char feed lines 51a, 51b, 51c, and 51d, the char properly flows through the respective char feed lines 51a, 51b, 51c, and 51d, and accumulation in the piping included in the respective char feed lines 51a, 51b, 51c, and 51d can be suppressed. As a result of it, it becomes possible to set large the inclination angle of the respective char feed lines 51a, 51b, 51c, and 51d and to suppress the height of the apparatus, and reduction in size of the apparatus can be achieved.

In addition, in the bin system of Example 1, the assist gas feed devices are set as the assist gas feed parts 54, 55a, 55b, 58a, 58b, 58c, and 58d that feed the inactive gas along the flow direction of the char. Accordingly, simplification of the apparatus can be achieved by applying as the assist devices the assist gas feed parts 54, 55a, 55b, 58a, 58b, 58c, and 58d that feed the inactive gas and also, a proper char conveyance system can be constructed without adversely affecting the char that flows through the respective lines 47, 49a, 49b, 51a, 51b, 51c, and 51d.

In addition, in the bin system of Example 1, inclination angle θ of the respective char discharge lines 47, 49a, and 49b and the respective switching lines 51a, 51b, 51c, and 51d is set to be not more than 60 degrees with respect to the horizontal direction, and the assist gas feed parts 54, 55a, 55b, 58a, 58b, 58c, and 58d are provided at the respective char discharge lines 47, 49a, and 49b and the respective switching lines 51a, 51b, 51c, and 51d that have been set to have the inclination angle θ. Accordingly, the inclination angle of the respective char discharge lines 47, 49a, and 49b and the respective switching lines 51a, 51b, 51c, and 51d can be made to be not more than 60 degrees, and it becomes possible to suppress the height of the apparatus, and reduction in size of the apparatus can be achieved.

In addition, in the char recovery apparatus of Example 1, the bin system is configured such that while the cyclone 41 is coupled to the syngas line 38 that discharges combustible gas from the coal gasifier 12, and the filters 42a and 42b are coupled to the first gas discharge line 46 in the cyclone 41, the bin 44 is coupled to the first char discharge line 47 in the cyclone 41 and the second char discharge lines 49a and 49b in the filters 42a and 42b, the hoppers 45a, 45b, 45c, and 45d are coupled to the bin 44 through the four switching lines 51a, 51b, 51c, and 51d, and the respective hoppers 45a, 45b, 45c, and 45d are coupled to the char return line 32, and in the char recovery apparatus of Example 1, the assist gas feed parts 54, 55a, and 55b are provided at the char discharge lines 47, 49a, and 49b and also, the assist gas feed parts 58a, 58b, 58c, and 58d are provided at the switching lines 51a, 51b, 51c, and 51d.

Accordingly, the coarse-grained char is separated from syngas by the cyclone 41, the fine-grained char is separated from the syngas by the filters 42a and 42b, the char is stored in the bin 44 through the char discharge lines 47, 49a, and 49b, and the char stored in the bin 44 is fed to the char return line 32 through the switching lines 51a, 51b, 51c, and 51d, and at this time, since the assist gas feed parts 54, 55a, 55b, 58a, 58b, 58c, and 58d assist the flow of the char that gravitationally falls down the respective char discharge lines 47, 49a, and 49b and the respective switching lines 51a, 51b, 51c, and 51d, the char properly flows through the respective lines 47, 49a, 49b, 51a, 51b, 51c, and 51d, and accumulation can be suppressed. As a result of it, it becomes possible to set large the inclination angle of the char discharge lines 47, 49a, and 49b and the switching lines 51a, 51b, 51c, and 51d and to suppress the height of the apparatus, and reduction in size of the apparatus can be achieved.

### Example 2

FIG. 3 is a schematic configuration diagram showing a main portion of a bin system pertaining to Example 2 of the present invention. It is to be noted that the same symbol is given to a member that has a function similar to the above-mentioned Example, and that detailed explanation thereof is omitted.

In the bin system of Example 2, as shown in FIG. 3, the first char discharge line 47 includes: the first linear part 101 and the second linear part 102; and the inclination part 103 that couples the respective linear parts 101 and 102 to each other, and the inclination part 103 is arranged so as to incline in the horizontal direction by the predetermined angle θ. Additionally, the assist gas feed device of this Example feeds inactive gas along the inner peripheral lower surface in the piping included in the first char discharge line 47.

That is, in the inclination part 103 of the first char discharge line 47, an assist gas feed part 121 is mounted at the lower part, and the assist gas discharge part 56 is mounted at the tip (lower end). The assist gas feed part 121 has: a gas feed pipe 122 that feeds inactive gas; and a plurality of (three in this Example) gas injection nozzles 123 that are formed in a longitudinal direction of the gas feed pipe 122 at a predetermined interval, each gas injection nozzle 123 enters the inclination part 103, and the inactive gas can be fed toward a tip side along an inner peripheral lower surface in piping included in the inclination part 103.

Accordingly, char flows down the first char discharge line 47 by means of the gravitational fall, and is stored in the bin 44 through the first linear part 101, the inclination part 103, and the second linear part 102. At this time, since in the assist gas feed part 121, the inactive gas is fed along a lower part inside the inclination part 103 from each gas injection nozzle 123 toward a flow direction of the char, flow of the char that moves along the inner lower surface of the piping included in the first char discharge line 47 is promoted, and accumulation can be suppressed.

As described above, in the bin system of Example 2, the assist gas feed part 121 as the assist gas feed device feeds the inactive gas along the inner peripheral lower surface in the piping included in the first char discharge line 47.

Accordingly, although the char moves along the inner peripheral lower surface in the piping included in the first char discharge line 47, the inactive gas is fed along the inner peripheral lower surface in this piping, thereby a frictional resistance between the char and the piping is reduced, flow of the char is made smooth, and accumulation of the char inside the piping can be prevented.

### Example 3

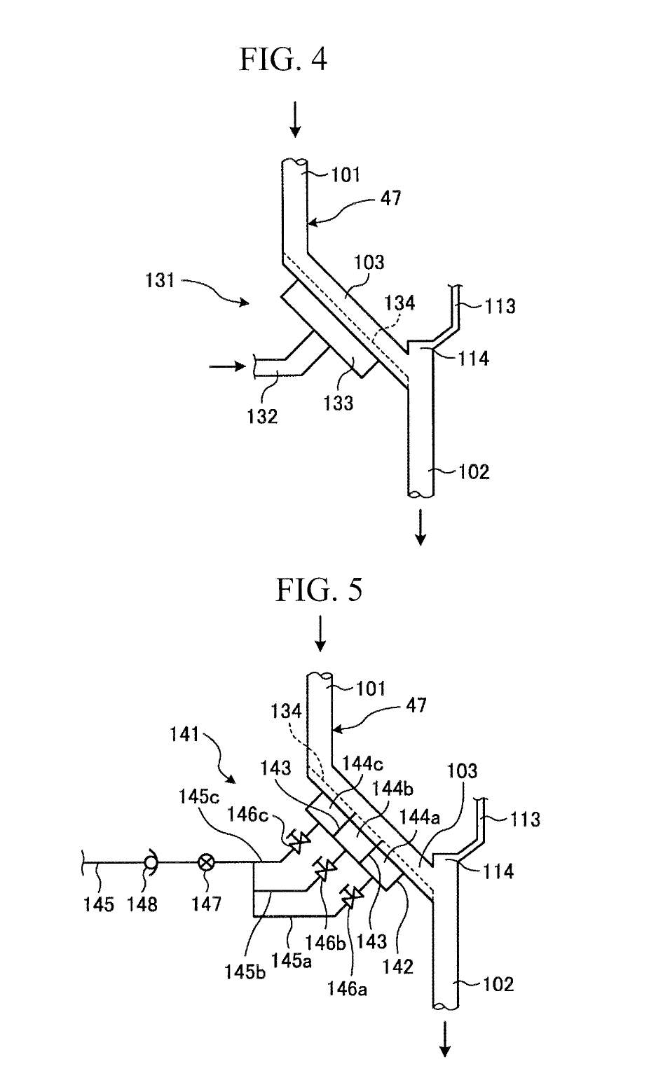

FIG. 4 is a schematic configuration diagram showing a main portion of a bin system pertaining to Example 3 of the present invention. It is to be noted that the same symbol is given to a member that has a function similar to the above-mentioned Examples, and that detailed explanation thereof is omitted.

In the bin system of Example 3, as shown in FIG. 4, the first char discharge line 47 includes: the first linear part 101 and the second linear part 102; and the inclination part 103 that couples the respective linear parts 101 and 102 to each other, and the inclination part 103 is arranged so as to incline in the horizontal direction by the predetermined angle θ. Additionally, in an assist gas feed device of this Example, an assist gas chamber is provided at a lower part of the piping included in the first char discharge line 47, and inactive gas is fed to the inner peripheral lower surface in the piping from the assist gas chamber.

That is, an assist gas feed part 131 is mounted at a lower part of the inclination part 103 of the first char discharge line 47. The assist gas feed part 131 has: a gas feed pipe 132 that feeds inactive gas; and an assist gas chamber 133 that is fixed to a lower part of the inclination part 103, and to which a tip of the gas feed pipe 132 is coupled, and the assist gas chamber 133 is communicated with an inside of the piping included in the inclination part 103 of the first char discharge line 47. Meanwhile, as for the piping included in the inclination part 103 of the first char discharge line 47, a porous plate 134 is laid at an inner lower part along a longitudinal direction. Therefore, inactive gas can be fed between the lower surface in the piping of the inclination part 103 and the porous plate 134 from the assist gas chamber 133.

It is to be noted that porous media (canvas, a sintered metal, a sintered wire gauze, etc.) with which the char flowing through the first char discharge line 47 does not flow through the assist gas chamber are preferably used as the porous plate 134.

Accordingly, char flows down the first char discharge line 47 by means of the gravitational fall, and is stored in the bin 44 through the first linear part 101, the inclination part 103, and the second linear part 102. At this time, in the assist gas feed part 131, the inactive gas is fed between the lower surface inside the inclination part 103 and the porous plate 134 from the assist gas chamber 133. The inactive gas is then fed to a space between the lower surface inside the inclination part 103 and the porous plate 134, and flows out onto a surface of the porous plate 134, a frictional resistance between the char and the porous plate is reduced, the char moving along the inner lower surface of the piping included in the first char discharge line 47, and also, internal friction in char powder is reduced to thereby promote the flow, and accumulation can be suppressed.

As described above, in the bin system of Example 3, the assist gas chamber 133 is provided at the lower part of the piping included in the first char discharge line 47, and the inactive gas is fed to the inner peripheral lower surface in the piping from the assist gas chamber 133.

Accordingly, the inactive gas is fed to the inner peripheral lower surface in the piping from the assist gas chamber 133 provided at the lower part of the piping included in the first char discharge line 47, thereby in the char that flows along the inner peripheral lower surface in the piping, a wall friction resistance and friction in the char powder are reduced by means of the inactive gas, the char smoothly flows, and accumulation of the powder inside the piping can be prevented.

### Example 4

FIG. 5 is a schematic configuration diagram showing a main portion of a bin system pertaining to Example 4 of the present invention. It is to be noted that the same symbol is given to a member that has a function similar to the above-mentioned Examples, and that detailed explanation thereof is omitted.

In the bin system of Example 4, as shown in FIG. 5, the first char discharge line 47 includes: the first linear part 101 and the second linear part 102; and the inclination part 103 that couples the respective linear parts 101 and 102 to each other, and the inclination part 103 is arranged so as to incline in the horizontal direction by the predetermined angle θ. Additionally, an assist gas feed device of this Example changes a feed amount of the inactive gas according to a flow rate of the char.

That is, an assist gas feed part 141 is mounted at the lower part of the inclination part 103 of the first char discharge line 47. In the assist gas feed part 141, an assist gas chamber 142 is fixed to the lower part of the inclination part 103, and a plurality of (three in this Example) gas chambers 144a, 144b, and 144c are partitioned by partition plates 143 in the char flow direction of the first char discharge line 47. The assist gas chamber 142 (gas chambers 144a, 144b, and 144c) is communicated with the inside of the piping included in the inclination part 103 of the first char discharge line 47. Meanwhile, as for the piping included in the inclination part 103 of the first char discharge line 47, the porous plate 134 is laid at the inner lower part along the longitudinal direction, and it is divided by the partition plates 143 of the respective assist gas chambers 144a, 144b, and 144c. Therefore, inactive gas can be fed to the lower surface in the piping of the inclination part 103 through the porous plate 134 for each of the assist gas chambers 144a, 144b, and 144c. A tip of a gas feed pipe 145 that feeds the inactive gas is branched into three branch pipes 145a, 145b, and 145c, and they are coupled to the gas chambers 144a, 144b, and 144c, respectively. Additionally, flow regulating valves 146a, 146b, and 146c are mounted at the respective branch pipes 145a, 145b, and 145c. In addition, a shutoff valve 147 and a check valve 148 are mounted at the gas feed pipe 145. It is to be noted that opening and closing control of the flow regulating valves 146a, 146b, and 146c and the shutoff valve 147 can be performed by a control device, which is not shown.

Accordingly, char flows down the first char discharge line 47 by means of the gravitational fall, and is collected or stored in the bin 44 through the first linear part 101, the inclination part 103, and the second linear part 102. At this time, the assist gas feed part 141 feeds the inactive gas between the lower surface in the inclination part 103 and the partition plates 143 from the respective gas chambers 144a, 144b, and 144c of the assist gas chamber 142. The inactive gas then flows out in the inclination part 103 from the surface of the porous plate 134, which is an upper surface of the respective assist gas chambers 144a, 144b, and 144c, reduces the frictional resistance between the char and the porous plate, the char moving along the inner lower surface of the piping included in the first char discharge line 47 and also, promotes the flow of the char by reducing the internal friction in the char powder, and can suppress accumulation.

At this time, a sensor, which is not shown, detects a flow rate of the char that flows through the first char discharge line 47 and outputs it to the control device, and the control device may adjust opening of the flow regulating valves 146a, 146b, and 146c according to the flow rate of the char, and may adjust a gas amount of the inactive gas fed to the respective gas chambers 144a, 144b, and 144c. That is, the opening of the flow regulating valves 146a, 146b, and 146c is changed according to the flow rate of the char that flows through the first char discharge line 47, and thereby stable discharge of the char can be performed. The gas amount of the inactive gas fed by changing the opening of the flow regulating valves 146a, 146b, and 146c depending on a discharge condition of the char is set as a minimum necessary flow rate.

In this case, although the gas amount of the inactive gas fed to the respective gas chambers 144a, 144b, and 144c is made uniform, for example, in order to increase a gas amount of the inactive gas of an upstream side of the inclination part 103, a gas amount of the inactive gas fed to the gas chamber 144a may be increased, and a gas amount of the inactive gas fed to the gas chamber 144c may be decreased.

As described above, in the bin system of Example 4, a feed amount of the inactive gas can be changed according to a flow rate of the char.

Accordingly, a proper amount of inactive gas is fed according to the flow rate of the char, thereby a conveyance speed of the char can be maintained at a proper speed and also, usage of the inactive gas can be reduced to reduce operation cost.

By the way, in the above-mentioned each Example, the bin system is configured such that the assist gas discharged after completion of assist is guided to an upstream side of the dust collecting device, such as the first filter 42a, through the gas discharge pipe 113, and joins a flow of syngas, and the char contained in the inactive gas recovered as used exhaust gas can also be recovered by the dust collecting device.

Here, when unburned coal is separated from syngas generated by the dust collecting device gasifying coal as in the IGCC and a chemical fuel plant having a coal gasifier, an exhaust gas flow rate of the assist gas is set to be not more than 10% of a syngas flow rate.

Such setting of the exhaust gas flow rate of the assist gas is performed for the following purpose: dilution of the syngas due to the assist gas is suppressed to the minimum; thereby combustion of a gas turbine combustion device 62 is stabilized; and purity deterioration of products of chemical fuel etc. is prevented.

In order to set the exhaust gas flow rate of the assist gas to be not more than 10% of the syngas flow rate, a passage sectional area of an assist gas input part and an assist gas input flow velocity are adjusted to thereby adjust an assist gas input amount.

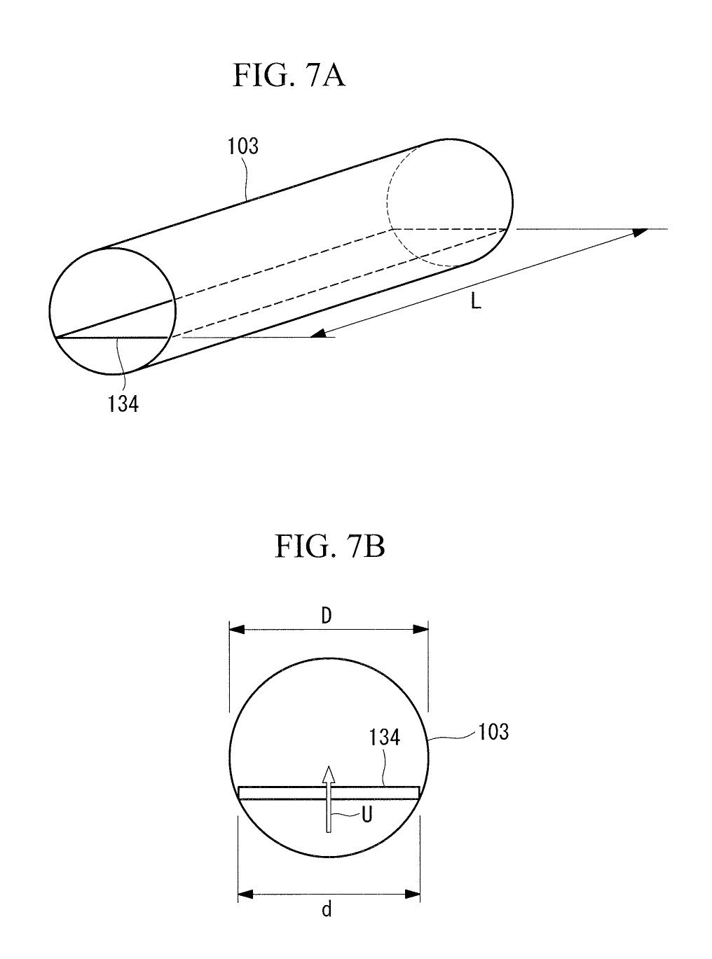

Here, with reference to FIGS. 7A and 7B, explained will be an adjustment example of the assist gas input amount in a case of applying to Example 4 of FIG. 5. It is to be noted that the symbol 103 in the drawings denotes the inclination part (piping), the symbol 134 in the drawings denotes the porous plate, and that the porous plate 134 of FIG. 5 is called a filter in the following explanation.

Assuming that a syngas flow rate is set as (Q1), an assist gas flow rate is (Q2), an assist gas input part opening area (A), a piping diameter (D), a piping length (L), a filter part assist gas input flow rate (U), a filter width (d), and the number of piping (n), the flow rate of the assist gas is decided by the following Expressions.

Q2=ΣAn×U

An=dn×Ln

Q2<Q1/10

That is, a total opening area (An) is a product of a filter width (dn) and a piping length (Ln) of the number of piping (n), and an assist gas flow rate (Q2) is a product of the total opening area (An) and the filter part assist gas input flow rate (U).

Accordingly, the assist gas flow rate (Q2) calculated by the above-described Expressions may be set so as to be not more than 10% ( 1/10) of the syngas flow rate (Q1) decided at a gasifier side. In such flow rate setting, for example, during driving, as shown in FIG. 6, a control valve 149 is provided at the gas feed pipe 145 that feeds inactive gas, opening adjustment based on a control signal is performed, and thereby adjustment of the assist gas input flow velocity can be performed.

It is to be noted that although the configuration and order of a valve of an assist gas feed device have been shown in the above-mentioned Examples, the present invention is not limited to this configuration and order. In addition, although the assist device is set as the assist gas feed device, the present invention is not limited to this configuration and, for example, the assist device may be set as a vibrating device etc. that vibrates piping, a porous plate, etc.

In addition, although in the above-mentioned Examples, the bin system pertaining to the present invention has been explained applying it to the char recovery apparatus in the IGCC, the application is not limited to the apparatus, and the bin system can be applied to any apparatus as long as the apparatus is the one that conveys powder in pulverized coal feed equipment and equipment unrelated to the IGCC.

### INDUSTRIAL APPLICABILITY

In a bin system and a char recovery apparatus pertaining to the present invention, an assist device that assists flow of powder gravitationally falling down a powder conveyance line, and thereby the powder conveyance line is made to incline to achieve reduction in size of the apparatus, and the bin system can be applied not only to an IGCC but to equipment that deals with powder, such as pulverized coal and unburned coal (fly ash), cement, and food.

### REFERENCE SIGNS LIST

11 Coal Feed Apparatus
12 Coal Gasifier
13 Char Recovery Apparatus
14 Gas Purification Equipment
15 Gas Turbine Equipment
16 Steam Turbine Equipment
17 Generator
18 Heat Recovery Steam Generator
19 Gas Purification Apparatus
41 Cyclone (First Dust Collecting Device)
42a First Filter (Second Dust Collecting Device)
42b Second Filter (Second Dust Collecting Device)
43a, 43b Rotary Valve
44 Bin (Closed Container)
45a, 45b, 45c, 45d Hopper
46 First Gas Discharge Line
47 First Char Discharge Line (Powder Discharge Line, First Unburned Coal Discharge Line)
48 Second Gas Discharge Line
49a, 49b Second Char Discharge Line (Powder Discharge Line)
50 First Pressure Equalizing Line
51a, 51b, 51c, 51d Switching Line (Powder Feed Line)
54, 55a, 55b, 58a, 58b, 58c, 58d, 121,131,141 Assist Gas Feed Part (Assist Device, Assist Gas Feed Device)
56, 57a, 57b, 59a, 59b, 59c, 59d Assist Gas Discharge Part
101, 102 Linear Part
103 Inclination Part
113 Gas Discharge Pipe
145 Gas Feed Pipe
149 Control Valve

1-10. (canceled)

11. A bin system comprising:
a container in which powder can be collected or stored;
a plurality of powder discharge lines that are arranged at a predetermined inclination angle at which the powder can be discharged in the container by means of gravitational fall;
a plurality of powder feed lines that are arranged at a predetermined inclination angle at which the powder collected or stored in the container can be fed by means of the gravitational fall; and
an assist gas feed device provided at at least one of the powder discharge line and the powder feed line and assisting flow of the powder,
wherein an assist gas flow rate which is input to the assist gas feed device is set to be not more than 10% of a flow rate syngas merged after completion of assist.

12. The bin system according to claim 11, wherein the assist device feeds inactive gas along a flow direction of the powder.

13. The bin system according to claim 12, wherein the assist gas feed device feeds the inactive gas along an inner peripheral lower surface in piping included in the powder discharge line or the powder feed line.

14. The bin system according to claim 12, wherein in the assist gas feed device, an assist gas chamber is provided at a lower part of the piping included in the powder discharge line or the powder feed line, and the inactive gas is fed to the inner peripheral lower surface in the piping from the assist gas chamber.

15. The bin system according to claim 12, wherein the assist gas feed device changes a feed amount of the inactive gas according to a flow rate of the powder.

16. The bin system according to claim 11, wherein the inclination angle of the powder discharge line or the powder feed line is set to be not more than 60 degrees with respect to a horizontal direction, and the assist gas feed device is provided at the line set to have the inclination angle not more than 60 degrees.

17. The bin system according to claim 11, wherein an assist gas discharge part connected to an inlet side of a dust collecting device from the assist device is provided.

18. A char recovery apparatus that recovers unburned coal from syngas generated by gasifying coal, the char recovery apparatus comprising:
a first dust collecting device that is coupled to a syngas generation line;
a second dust collecting device that is coupled to a first gas discharge line in the first dust collecting device;
a bin that is coupled to a first unburned coal discharge line in the first dust collecting device and a second unburned coal discharge line in the second dust collecting device;
a plurality of unburned coal feed lines that feed unburned coal to an unburned coal return line from the bin; and
an assist gas feed device that assists flow of the unburned coal gravitationally falling down each of the unburned coal discharge lines or the unburned coal feed line,
wherein an assist gas flow rate which is input to the assist gas feed device is set to be not more than 10% of a flow rate of syngas merged after completion of assist.

19. The bin system according to claim 14, wherein the assist gas chamber comprises a gas feed system which can adjust a feed flow rate of an inactive gas for each of a plurality of gas chambers partitioned in a flow direction of the powder.
